(19) United States
(12) Patent Application Publication
(10) Pub. No.: US 2021/0095181 A1
(43) Pub. Date: Apr. 1, 2021

(54) READILY WATER-DISPERSIBLE BETA-GLUCAN SUSPENSIONS

(71) Applicant: CARGILL, INCORPORATED, Wayzata, MN (US)

(72) Inventors: Timothy Walter ABRAHAM, Minnetonka, MN (US); Jeffrey J. MALSAM, Minneapolis, MN (US); Eric Stanley SUMNER, Minneapolis, MN (US)

(73) Assignee: CARGILL, INCORPORATED, Wayzata, MN (US)

(21) Appl. No.: 16/499,704

(22) PCT Filed: Mar. 19, 2018
(86) PCT No.: PCT/US2018/023103

§ 371 Date: Sep. 30, 2019

Related U.S. Application Data
(60) Provisional application No. 62/477,632, filed on Mar. 28, 2017.

(51) Int. Cl. C09K 8/588; C08L 5/00; C08B 37/00

(52) U.S. Cl. CPC C09K 8/588; C08B 37/0024; C08L 5/00

(57) ABSTRACT

Readily water-miscible beta-glucan suspensions and methods of making and using the same. A readily water-miscible beta-glucan suspension includes a beta-glucan and a water-miscible organic fluid that comprises an alcohol, an alpha-hydroxy acid alkyl ester, a polyalkylene glycol alkyl ether, or a combination thereof, wherein the suspension is sufficient such that mixing with water at a shear rate of 40,000 s-1 or more forms a homogeneous mixture of the suspension and the water. The present invention also provides methods of dispersing the water-miscible beta-glucan suspension in water to form homogenous mixtures of the suspension and the water, methods of treating subterranean formations with such homogeneous mixtures, and methods of making the suspension.

### BACKGROUND

Beta-glucans can be used as thickeners in aqueous subterranean treatment fluids, such as for enhanced oil recovery (EOR). Due to transportation costs and lack of space (particularly for off-shore applications), a fully-diluted and ready-to-use aqueous beta-glucan solution is expensive and undesirable; therefore, a solid or concentrated form of the beta-glucan is preferable for such applications to avoid the unneeded transport of water. However, conventional forms of beta-glucans are difficult to solubilize or disperse into solution to form effective subterranean treatment fluids and suffer from problems such as long required mixing times, high shear requirements for mixing, insufficient viscosity build during mixing, and poor filterability during subterranean use (e.g., clogs pores of subterranean formations).

### SUMMARY OF THE INVENTION

The present invention provides a readily water-dispersible beta-glucan (BG) suspension. The suspension can include a BG and an organic fluid that includes an alcohol, an alpha-hydroxy acid alkyl ester, a polyalkylene glycol alkyl ether, or a combination thereof. The suspension can be sufficient such that mixing with water at a shear rate less than about 40,000 s⁻¹ forms a homogeneous mixture of the BG and the water.

The present invention provides a method of dispersing the water-dispersible BG suspension in water. The method can include mixing the water-dispersible BG suspension and water to form a mixture of the BG and the water.

The present invention provides a method of treating a subterranean formation. The method can include mixing a readily water-dispersible BG suspension including a BG and an organic fluid that includes an alcohol, an alpha-hydroxy acid alkyl ester, a polyalkylene glycol alkyl ether, or a combination thereof, with water to form a mixture of the suspension and the water. The suspension can be sufficient such that mixing with water at a maximum shear rate of less than 40,000 s⁻¹ forms a homogenous mixture of the BG and the water having a transmittance of about 95.0% to about 100% at 600 nm. The method can include placing the mixture of the suspension and the water in a subterranean formation. The method can include performing an enhanced oil recovery procedure in the subterranean formation using the mixture of the suspension and the water, wherein the mixture of the suspension and the water in the subterranean formation sweeps petroleum in the subterranean formation toward a well. The method can also include removing the petroleum from the subterranean formation via the well.

The present invention provides a method of making the water-dispersible BG suspension. The method can include combining the BG and the organic fluid to form the water-dispersible BG suspension.

The present invention can have certain advantages over other beta-glucans, suspensions including the same, and methods of using beta-glucans and beta-glucan suspensions, at least some of which are unexpected. For example, some beta-glucans or suspensions including the same can require long mixing times, high shear rates, or a combination thereof, to disperse the beta-glucan in water. In various aspects, the beta-glucan suspension of the present invention can provide a homogeneous mixture of water and the beta-glucan using a shorter mixing time, less shear, or a combination thereof, as compared to other beta-glucans or suspensions including the same.

Various beta-glucans or suspensions including the same can suffer from slow or insufficient viscosity build during mixing with water, such that an ultimate viscosity of the fully-diluted and dispersed beta-glucan can only be achieved with long mixing times or can never be achieved. In various aspects, the beta-glucan suspension of the present invention can provide a homogeneous mixture of water and the beta-glucan with a more rapid viscosity build, with a final viscosity closer to or equal to the ultimate viscosity, or a combination thereof, as compared to other beta-glucans or suspensions including the same.

Some fully-diluted and ready-to-use beta-glucan subterranean treatment fluids can clog pores and flowpaths in subterranean formations which can result in decreased production rates or increased pressures that can damage the subterranean formation. In various aspects, the beta-glucan suspension of the present invention can be used to provide a homogeneous mixture of water and the beta-glucan that provides less clogging of pores and flowpaths (e.g., that has better filterability, as defined herein), as compared to other beta-glucans or suspensions including the same. In various aspects, the beta-glucan suspension of the present invention can provide homogeneous mixtures of water and the suspension having less or no surfactants but having better filterability than mixtures formed from other beta-glucans or suspensions including the same.

With various beta-glucans or suspensions including the same, it can be difficult or impossible to prepare fully-diluted and ready-to-use aqueous solutions using salt water, especially with high salt concentrations, due to problems such as insufficient viscosity and insufficient dispersion of the beta-glucan in the water. In various aspects, the beta-glucan suspension of the present invention can be diluted using salt water to form a homogenous mixture of the water and the beta-glucan with better dispersion of the beta-glucan (e.g., more dispersed), less mixing time or lower shear rate for preparation, better viscosity performance (e.g., faster viscosity build or higher final viscosity), or a combination thereof, as compared to other beta-glucans or suspensions including the same.

Some beta-glucans or suspensions including the same can form fully-diluted and ready-to-use treatment fluids that perform poorly under heated conditions (e.g., 70° C. to 150° C.), such as having insufficient or decreasing viscosity. In various aspects, the beta-glucan suspension of the present invention can be used to form a homogenous mixture of the water and the beta-glucan with better performance under heated conditions, such as higher viscosity or less or no viscosity degradation, as compared to other beta-glucans or suspensions including the same.

Various beta-glucans or suspensions including the same can form clumps of beta-glucan when placed into water under low shear, conventionally referred to as “fish eyes.” In various aspects, the beta-glucan suspension of the present invention can be solubilized or dispersed in water under a low shear with less or no occurrence of fish eyes, as compared to other beta-glucans or suspensions including the same dispersed in water under the same shear rate.

Various beta-glucan suspensions can be difficult or impossible to fully solubilize or disperse in water such that no second phase is visible. In various aspects, the beta-glucan suspension of the present invention can be solubilized or dispersed in water more easily and completely (e.g., with lower shear rate, using less time, or a combination thereof), as compared to other beta-glucans or suspensions, such that no second phase is visible, even after centrifugation, as compared to other beta-glucans or suspensions including the same.

In various aspects, the beta-glucan suspension of the present invention can be classified as more environmentally friendly, less hazardous, or a combination thereof, than other beta-glucans or suspensions including the same. For example, the beta-glucan suspension of the present invention can avoid combustible classification, flammable classification, or both. In some examples, the beta-glucan suspension of the present invention can include all or predominantly materials that are certified as environmentally safe or as posing little or no risk to the environment, to health, or a combination thereof, by a variety of nations.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some aspects, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain aspects there is no hydrocarbyl group.

The term “downhole” as used herein refers to under the surface of the earth, such as a location within or fluidly connected to a wellbore.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, water shut-off, conformance, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some aspects, a flow pathway can be a water source and can include water. In some aspects, a flow pathway can be a petroleum source and can include petroleum. In some aspects, a flow pathway can be sufficient to divert from a wellbore, fracture, or flow pathway connected thereto at least one of water, a downhole fluid, or a produced hydrocarbon.

As used herein, the term “suspension” means a homogeneous mixture of BG in suspension liquid. Such suspension may be achieved via continuous agitation.

As used herein, the term “water-dispersible” means to cause the BG to be distributed uniformly throughout the continuous water phase. The dispersed material and water are two separate phases forming a heterogeneous mixture.

As used herein, the term “BG” means a beta glucan material that comprises an amount of at least 75 wt % beta glucan content, and more preferably from 82 wt % to 92 wt % beta glucan content.

### Readily Water-Dispersible Beta-Glucan Suspension.

The present invention provides a readily water-dispersible beta-glucan suspension including a BG and an organic fluid that includes an alcohol, an alpha-hydroxy acid alkyl ester, a polyalkylene glycol alkyl ether, or a combination thereof. The suspension includes the solid or partially dissolved BG in the organic fluid, with the BG homogeneously or heterogeneously distributed in the organic fluid. The suspension can be sufficient such that mixing with water at a shear rate less than about 40,000 s⁻¹ forms a homogeneous mixture of the BG and the water.

The homogeneous mixture of the BG and the water can be any suitable homogeneous mixture. The BG can be substantially fully dissolved in the mixture, or can be a finely dispersed solid (e.g., having a particle size, such as a largest dimension, of less than 1,000 microns, 500 microns, 10 microns, or less than 1 micron, such as an average particle size). The homogeneous mixture can be substantially free of fish eyes (e.g., substantially free of clumps of the BG or any other non-homogeneously distributed BG). The organic fluid can be fully dissolved in the water such that no second phase is visible, such that the homogeneous mixture of the BG and the water is a homogeneous mixture of the BG, the water, and the organic fluid, or is a homogeneous mixture of the suspension and the water. In some aspects, at least some of the organic fluid can form a second phase with the water. Whether the mixture of the BG and water is homogeneous or not can be determined, for example, based on whether the transmittance of the mixture is greater than about 95.0% measured at a wavelength of 600 nm, as further described herein.

The mixture of the suspension and the water formed by mixing at a shear rate of less than 40,000 s⁻¹ can have no visible liquid-liquid interface, such as after no centrifugation, or such as after centrifugation for 5 minutes (e.g., 30 seconds or less, or less than, equal to, or greater than about 1 minute, 2, 3, 4, 5, 6, 8, 10, 20, 30, 40, 50 minutes, or after about an hour or more) at 5000 RPM (e.g., 1,000 RPM or less, or less than, equal to, or greater than about 2,000 RPM, 3,000 RPM, 4,000 RPM, 5,000 RPM, 6,000 RPM, 8,000 RPM, 10,000 RPM, 15,000 RPM, 20,000 RPM, 30,000 RPM, or about 50,000 RPM or more). The centrifugation can be performed, for example, on a centrifuge having a radius of about 1 mm to about 1 m, 2 mm, 4, 6, 8, 10, 15, 20, 30, 40, 50, 75, 100, 150, 200, 250, 300, 400, 500, 600, 700, 800, 900 mm, or about 1 m or more.

The mixing of the suspension with the water to form the homogeneous mixture of the BG and the water can include a maximum shear rate of less than about 40,000 s⁻¹ (e.g., the mixing can be free of shear rates equal to or greater than 40,000 s⁻¹), or a maximum of about 100 s⁻¹ to about 40,000 s⁻¹, or can include a shear rate of about 100 s⁻¹ or less, or less than, equal to, or greater than about 200 s⁻¹, 400, 600, 800, 1,000, 1,500, 2,000, 2,500, 3,000, 3,500, 4,000, 4,500, 5,000, 6,000, 7,000, 8,000, 9,000, 10,000, 15,000, 20,000, 25,000, 30,000, 35,000 s⁻¹, or about 40,000 s⁻¹ or more. The mixing can be performed for any suitable duration, such as for at least 10 seconds, for about 10 seconds to about 48 hours, for about 1 minute to about 12 hours, or about 0.001 seconds or less, or less than, equal to, or greater than about 0.005 second, 0.01, 0.05, 0.1, 0.5, 1, 1.5, 2, 3, 4, 5, 6, 8, 10, 12, 14, 16, 18, 20, 25, 30, 35, 40, 45, 50, 55 seconds, 1 minute, 2, 3, 4, 5, 6, 8, 10, 12, 14, 16, 18, 20, 30, 40, 50 minutes, or about 1 hour, 2, 3, 4, 5, 6, 7, 8, 9, 10, 12, 14, 16, 18, 20, 22, 24, 26, or about 48 hours or more.

The beta-glucan can be any suitable proportion of the homogeneous mixture of the BG and the water formed by mixing the suspension and the water using a shear rate of less than 40,000 s⁻¹. For example, the BG can be about 0.001 wt % to about 10 wt % of the homogeneous mixture of the BG and the water, about 0.01 wt % to about 1 wt %, about 0.05 wt % to about 0.5 wt %, or about 0.001 wt % or less, or less than, equal to, or greater than about 0.01 wt %, 0.05, 0.1, 0.2, 0.3, 0.4, 0.5, 0.6, 0.8, 1, 1.5, 2, 2.5, 3, 4, 5, 6, 7, 8, 9 wt %, or about 10 wt % or more of the homogeneous mixture of the BG and the water. The suspension can be any suitable proportion of the mixture of the suspension and the water, such as about 0.001 wt % to about 60 wt %, or about 0.01 wt % to about 50 wt %, or about 0.001 wt % or less, or less than, equal to, or greater than about 0.01 wt %, 0.1, 0.5, 1, 1.5, 2, 2.5, 3, 4, 5, 6, 8, 10, 12, 14, 16, 18, 20, 25, 30, 35, 40, 45, 50, 55, or about 60 wt % of the mixture of the suspension and the water.

The mixing of the suspension with the water to form the homogeneous mixture of the water and the BG using a shear rate of less than 40,000 s⁻¹ can be performed at any suitable temperature, such as room temperature or ambient temperature, such as about 0° C. to about 150° C., about 20° C. to about 50° C., or about 0° C. or less, or less than, equal to, or greater than about 10° C., 20, 30, 40, 50, 60, 70, 80, 90, 100, 110, 120, 130, 140° C., or about 150° C. or more. The mixing can be performed at any suitable pressure, such as at atmospheric pressure, such as about 0.1 MPa to about 100 MPa, about 0.1 MPa to about 1 MPa, or about 0.1 MPa or less, or less than, equal to, or greater than about 0.2 MPa, 0.5, 1, 5, 10, 20, 25, 50, 75 MPa, or about 100 MPa or more.

The homogeneous mixture of the BG and the water formed by mixing the suspension and the water using a shear rate of less than 40,000 s⁻¹ can have a transmittance of greater than about 95.0% measured at a wavelength of 600 nm, or about 95.0% to about 100%, or 95.0% to about 99.99%, or less than 95.0%, or less than, equal to, or greater than about 95.5%, 96, 96.5, 97, 97.5, 98, 98.5, 99, 99.1, 99.2, 99.3, 99.4, 99.5, 99.6, 99.7, 99.8, 99.9, 99.95%, or about 99.99% or more measured at a wavelength of 600 nm.

The homogeneous mixture of the BG and the water formed by mixing the suspension and the water using a shear rate of less than 40,000 s⁻¹ can have any suitable Filterability Ratio, measured as described herein in the Examples section. The Filterability Ratio indicates the degree to which the mixture causes pore clogging over time, and is a ratio of time required for 20 g flow at a steady pressure through a filter at a later time divided by the time required for 20 g flow through the filter at an earlier time, with a ratio of 1 indicating no pore clogging (e.g., equal times required for flow at later and earlier times through the same filter at the same pressure). The Filterability Ratio can be less than about 1.5, less than about 1.2, or about 1.0 to about 1.5, about 1.01 to about 1.20, or about 1.0, or less than, equal to, or greater than about 1.01, 1.02, 1.04, 1.06, 1.08, 1.10, 1.12, 1.14, 1.16, 1.18, 1.20, 1.25, 1.30, 1.35, 1.40, 1.45, or about 1.50 or more. The Filterability Ratio can be determined by passing the sample through a filter having a pore size of about 1.2 microns (e.g., 47 mm diameter, 1.2 μm pore size, EMD Millipore mixed cellulose esters filter (part #RAWP4700)) using a pressure to achieve a flux of about 1-3 g/s and maintaining such pressure consistently while measuring the mass of filtrate produced. The Filterability Ratio is (time(180 g)−time (160 g))/(time(80 g)−time (60 g)). Prior to passing the sample through the 1.2 micron filter, the sample can first be optionally passed through a filter having a pore size of about 2 microns (e.g., 47 mm diameter Millipore AP25 filter (AP2504700)) at about 100-300 mL/min.

The water can be any suitable proportion of the homogeneous mixture of the BG and the water, such as about 45 wt % to about 99.999 wt %, or about 50 wt % to about 99.99 wt %, or about 45 wt % or less, or less than, equal to, or greater than about 50 wt %, 55, 60, 65, 70, 75, 80, 81, 82, 83, 84, 85, 86, 87, 88, 89, 90, 91, 92, 93, 94, 95, 96, 97, 98, 99, 99.9, 99.99 wt %, or about 99.999 wt % or more. The water can include fresh water, salt water, brine, produced water, flowback water, brackish water, sea water, synthetic sea water, or a combination thereof. For a salt water, the one or more salts therein can be any suitable salt, such as at least one of NaBr, CaCl₂, CaBr₂, ZnBr₂, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof. The water can have any suitable total dissolved solids level, such as about 1,000 mg/L to about 250,000 mg/L, or about 1,000 mg/L or less, or about 0 mg/L, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The water can have any suitable salt concentration, such as about 1,000 ppm to about 300,000 ppm, or about 1,000 ppm to about 150,000 ppm, or about 0 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the water can have a concentration of at least one of NaBr, CaCl₂, CaBr₂, ZnBr₂, KCl, and NaCl of about 0.1% w/v to about 20% w/v, or about 0%, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

In the suspension including the organic fluid and the BG, the BG can be substantially in the form of a solid and the organic fluid in the suspension can be in the form of a liquid. The BG can be homogeneously distributed in the organic fluid. The suspension including the organic fluid and the BG can include one type of BG or more than one type of BG. The beta glucan composition in the BG can be a 1,3 beta-glucan. The beta glucan composition in the BG can be a 1,3-1,6 beta-D-glucan. The beta glucan composition in the BG can be a 1,3-1,4 beta-D-glucan, such as having a main chain from beta-1,3-glycosidically bonded glucose units, and side groups which are formed from glucose units and are beta-1,6-glycosidically bonded thereto. Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

The beta glucan composition in the BG can be scleroglucan, a branched BG with one out of three glucose molecules of the beta-(1,3)-backbone being linked to a side D-glucose unit by a (1,6)-beta bond produced from, e.g., fungi of the Sclerotium. The beta glucan composition in the BG can be schizophyllan, a branched BG having one glucose branch for every third glucose residue in the beta-(1,3)-backbone produced from, e.g., the fungus Schizophyllan commune.

The one or more beta-glucans can be any suitable proportion of the suspension, such as about 10 wt % to about 60 wt % of the suspension, about 20 wt % to about 50 wt % of the suspension, or about 10 wt % or less, or less than, equal to, or greater than about 15 wt %, 20, 25, 30, 35, 40, 45, 50, 55 wt %, or about 60 wt % or more. Fungal strains that secrete such glucans are known to those skilled in the art. Examples include Schizophyllum commune, Sclerotium rolfsii, Sclerotium glucanicum, Monilinla fructigena, Lentinula edodes, or Botrygs cinera. The beta-glucan can have desirable characteristics for treatment of subterranean formations as described in co-pending International PCT Applications PCT/US17/024464, PCT/US17/024477, PCT/US17/036730, PCT/US17/065331, PCT/US17/052448.

The BG in the suspension can have any suitable particle size, such as a largest dimension, such as a particle size of about 10 microns to about 1,000 microns, about 100 microns to about 500 microns, or about 10 microns or less, or less than, equal to, or greater than about 25 microns, 50, 75, 100, 150, 200, 250, 500, 750 microns, or about 1,000 microns or more. The particle size can be an average particle size (e.g., number average).

The organic fluid can be any suitable proportion of the suspension, such as about 20 wt % to about 90 wt % of the suspension, about 40 wt % to about 80 wt %, about 20 wt % or less, or less than, equal to, or greater than about 25, 30, 35, 40, 45, 50, 55, 60, 65, 70, 75, 80, 85 wt %, or about 90 wt % or more of the suspension.

The organic fluid can be or include one or more alcohols. The alcohol in the suspension can include a single —OH group (e.g., a mono-ol), or a plurality of —OH groups (e.g., a polyol). The alcohol can be a substituted or unsubstituted (C₁-C₂₀) alcohol, such as a (C₁-C₂₀)hydrocarbon or (C₁-C₂₀)alkane that includes at least one —OH substituent and that is otherwise substituted or unsubstituted. The alcohol can be a (C₁-C₈)hydrocarbon or (C₁-C₈)alkane that includes at least one —OH substituent and that is otherwise substituted or unsubstituted. The alcohol can be a (C₁-C₈)alkane that includes at least one —OH substituent and that is otherwise unsubstituted, such as methanol, ethanol, n-propanol, iso-propanol, n-butanol, iso-butanol, tert-butanol, sec-butanol, a pentanol, a hexanol, a heptanol, an octanol, or a combination thereof, wherein alcohols having 3 or more carbon atoms can be linear (e.g., normal) or branched (e.g., iso, tert, sec, and the like). The alcohol can be butanol, isopropanol, or a combination thereof. The alcohol can be a water-miscible alcohol.

The organic fluid can be or include one or more alpha-hydroxy acid alkyl esters. The alpha-hydroxy acid alkyl ester can be a (C₁-C₂₀)alkyl (C₂-C₂₀)alpha-hydroxy acid. The alpha-hydroxy acid alkyl ester can be a (C₁-C₅)alkyl (C₂-C₃)alpha-hydroxy acid. The alpha-hydroxy acid alkyl ester can be a (C₁-C₅)alkyl lactate. The alpha-hydroxy acid alkyl ester can be ethyl lactate.

The organic fluid can be or include one or more polyalkylene glycol alkyl ethers. The polyalkylene glycol alkyl ether can be a poly(C₂-C₃)alkylene glycol (C₁-C₂₀)alkyl ether. The polyalkylene glycol alkyl ether can be a polypropylene glycol (C₁-C₅)alkyl ether. The polyalkylene glycol alkyl ether can be dipropylene glycol methyl ether.

In some aspects, the suspension including the BG and the organic fluid can further include water (e.g., “suspension water”). The suspension water can be about 0 wt % to about 45 wt % of the suspension, about 2 wt % to about 40 wt %, or about 0 wt %, or less than, equal to, or greater than about 1 wt %, 2, 3, 4, 5, 6, 7, 8, 9, 10, 12, 14, 15, 20, 25, 30, 35 wt %, or about 40 wt % or more of the suspension. The suspension water can include any suitable water, such as fresh water, salt water, brine, produced water, flowback water, brackish water, sea water, synthetic sea water, or a combination thereof.

The suspension can have any suitable pH, such as a pH of about 5 to about 9, about 6 to about 7.5, about 5 or less, or less than, equal to, or greater than about 5.5, 6, 6.5, 7, 7.5, 8, 8.5, or about 9 or more.

The suspension can have any suitable viscosity. The suspension can have a viscosity of about 0.1 to about 2 million cP at 70° C. measured at a shear rate of 100 s⁻¹.

A mixture of the suspension and water can quickly develop viscosity. For example, the suspension can be sufficient such that a test mixture including water and the suspension (e.g., having a wt % of the suspension of about 0.001 wt % to about 60 wt %, or about 0.01 wt % to about 50 wt %, or about 0.001 wt % or less, or less than, equal to, or greater than about 0.01 wt %, 0.1, 0.5, 1, 1.5, 2, 2.5, 3, 4, 5, 6, 8, 10, 12, 14, 16, 18, 20, 25, 30, 35, 40, 45, 50, 55, or about 60 wt %) subjected to a shear rate of 1,000 s⁻¹ to 400,000 s⁻¹ (e.g., about 1,000 s⁻¹ to about 400,000 s⁻¹, about 40,000 s⁻¹ to about 400,000 s⁻¹, 40,000 s⁻¹ to about 300,000 s⁻¹, 40,000 s⁻¹ to about 200,000 s⁻¹, or about 1,000 s⁻⁵ or less, or less than, equal to, or greater than about 2,000 s⁻¹, 5,000, 10,000, 20,000, 30,000, 40,000, 50,000, 60,000, 70,000, 80,000, 90,000, 100,000, 125,000, 150,000, 175,000, 200,000, 250,000, 300,000, 350,000 s⁻¹, or about 400,000 s⁻¹ or more) at standard temperature and pressure for a duration that is about 0.001 seconds to about 60 seconds (e.g., about 0.5 seconds to about 10 seconds, about 1 second to about 20 seconds, about 1.5 seconds to about 30 seconds, about 0.001 seconds or less, or less than, equal to, or greater than about 0.005 second, 0.01, 0.05, 0.1, 0.5, 1, 1.5, 2, 3, 4, 5, 6, 8, 10, 12, 14, 16, 18, 20, 25, 30, 35, 40, 45, 50, 55 seconds, or about 60 seconds or more) obtains about 50% to about 100% of an ultimate viscosity of the test mixture (e.g., about 50% or less, or less than, equal to, or greater than about 55%, 60, 65, 70, 75, 80, 85, 90, 95%, or about 100%), and the test mixture subjected to the same shear rate for twice the same duration at standard temperature and pressure obtains about 70% or more of the ultimate viscosity of the test mixture (e.g., about 70% or less, or less than, equal to, or greater than about 75%, 80, 85, 90, 95%, or about 100%). The water in the test mixture can include fresh water, salt water, brine, produced water, flowback water, brackish water, sea water, synthetic sea water, or a combination thereof. The ultimate viscosity of the test mixture at 30 rpm can be greater than about 2 cP and less than about 1,000 cP, greater than about 50 cP and less than about 200 cP, or about 2 cP or less, or less than, equal to, or greater than about 3 cP, 4, 5, 6, 8, 10, 15, 20, 25, 50, 75, 100, 125, 150, 175, 200, 250, 300, 400, 500, 750 cP, or about 1,000 cP or more.

### Method of Dispersing the Water-Dispersible Beta-Glucan Suspension in Water.

The present invention provides a method of dispersing the water-dispersible BG suspension in water. The method can be any suitable method of combining any water-dispersible BG suspension disclosed herein in water. The method includes mixing the water-dispersible suspension and water to form a mixture of the suspension and the water (e.g., a homogeneous mixture of the BG and the water, or an inhomogeneous mixture of the BG and the water).

The method can include mixing the water-dispersible suspension and the water with a shear rate of less than 40,000 s⁻¹; however, the method can include mixing the water-dispersible suspension and the water at any suitable shear rate, such as shear rates of 40,000 s⁻¹ or more. The method can include mixing the water-dispersible BG suspension and the water to form the mixture of the suspension and water using a maximum shear rate of less than about 40,000 s⁻¹ (e.g., free of shear rates of 40,000 s⁻¹ or more), or using a maximum shear rate of about 100 s⁻¹ to about 400,000 s⁻¹, or about 100 s⁻¹ to about 40,000 s⁻¹, or about 100 s⁻¹ or less, or less than, equal to, or greater than about 200 s⁻¹, 400, 600, 800, 1,000, 2,000, 2,500, 5,000, 10,000, 20,000, 25,000, 50,000, 75,000, 100,000, 150,000, 200,000, 250,000, 300,000, 350,000 s⁻¹, or about 400,000 s⁻¹ or more. The mixing can occur for any suitable duration, such as for at least 0.001 seconds, for about 10 seconds to about 48 hours, for about 1 minute to about 12 hours, or about 0.001 seconds or less, or less than, equal to, or greater than about 0.005 second, 0.01, 0.05, 0.1, 0.5, 1, 2, 3, 4, 5, 6, 8, 10, 20, 30, 40, 50 seconds, 1 minute, 2 minutes, 3, 4, 5, 10, 15, 20, 25, 30, 35, 40, 45, 50, 55 minutes, 1 hour, 1.5, 2, 2.5, 3, 3.5, 4, 5, 6, 8, 10, 12, 14, 16, 18, 20, 22, 24, 36 hours, or about 48 hours or more.

The method can include mixing the suspension with the water at a temperature of 0° C. to about 150° C., 70° C. to about 120° C., 20° C. to about 50° C., or about 0° C. or less, or less than, equal to, or greater than about 10° C., 20, 30, 40, 50, 60, 70, 80, 90, 100, 110, 120, 130, 140° C., or about 150° C. or more. The method can include mixing the suspension with the water at a pressure of about 0.1 MPa to about 100 MPa, about 0.1 MPa to about 1 MPa, about 0.1 MPa or less, or about 0.2 MPa, 0.5, 1, 5, 10, 20, 25, 50, 75 MPa, or about 100 MPa or more.

The method can include placing the mixture of the suspension and the water in a subterranean formation and performing a subterranean treatment with the same. The subterranean treatment can be any suitable subterranean treatment, such as hydraulic fracturing, enhanced oil recovery, water shut-off, conformance, or a combination thereof. The mixing of the suspension with the water can be performed at any suitable time relative to the placing of the mixture of the suspension and the water in the subterranean formation. The mixing of the suspension with the water can be performed above-surface, or in the subterranean formation (e.g., the mixture of the suspension and the water can be formed downhole). The mixing with the water to form the mixture of the suspension and the water can include on-the-fly mixing, such as including adding the suspension to an aqueous subterranean treatment fluid (e.g., water and any other optional component) as the aqueous subterranean treatment fluid is being placed in the subterranean formation. The overall time from formation of the mixture of the suspension and the water to placement of the mixture in the subterranean formation can be less than about 30 minutes, such as about 10 seconds to about 48 hours, about 1 minute to about 12 hours, or about 0.001 seconds or less, or less than, equal to, or greater than about 0.005 second, 0.01, 0.05, 0.1, 0.5, 1, 1.5, 2, 3, 4, 5, 6, 8, 10, 12, 14, 16, 18, 20, 25, 30, 35, 40, 45, 50, 55 seconds, 1 minute, 2, 3, 4, 5, 6, 8, 10, 12, 14, 16, 18, 20, 30, 40, 50 minutes, or about 1 hour, 2, 3, 4, 5, 6, 7, 8, 9, 10, 12, 14, 16, 18, 20, 24, 36, or about 48 hours or more. The method can further include removing petroleum from the subterranean formation.

The method can include performing an enhanced oil recovery procedure (e.g., polymer flooding) in the subterranean formation using the mixture of the suspension and the water. The mixture of the suspension and the water can sweep petroleum in the subterranean formation toward a well (e.g., a different well from a well the mixture was originally placed in). The method can include removing the petroleum from the well (e.g., at least some of the petroleum that was swept toward the well).

### Method of Making the Water-Dispersible Beta-Glucan Suspension.

The present invention provides a method of making the water-dispersible BG suspension. The method can be any suitable method that forms the water-dispersible BG suspension described herein. The method can include combining a BG and the organic fluid to form the water-dispersible BG suspension. The BG can be a BG that is not precipitated after such treatment (and optionally precipitated before) and before forming the suspension, as precipitation can cause formation of large fibrous particles that can make dispersion of a precipitated and subsequently unprocessed BG in a solution difficult and that can give solutions made from the BG poor filterability.

### EXAMPLES

Various aspects of the present invention can be better understood by reference to the following Examples which are offered by way of illustration. The present invention is not limited to the Examples given herein.

Stir plate shear rate calculation. The shearing elements used were about 2.5-10 cm in diameter with about a 1-2 mm gap between the shearing element and the bottom of the beaker. The shear rate was about 700 rpm. D*π*rpm*(1 min/60 s)=distance travelled of outer edge of shearing element per second, which can be divided by the gap distance to estimate the shear rate. (2.5 to 10 cm)*π*700 rpm*(1 min/60 s)/0.1 to 0.2 cm=about 460 s⁻¹ to about 3,670 s⁻¹.

### Part I. Preparation of Beta-Glucan.

Using a 5000 liter jacketed vessel with moderate agitation, 7 g/L of commercial Actigum® CS6 from Cargill (crude powder blend of scleroglucan and Sclerotium rolfsii organism powder) was added to 2400 liters of 11.8° C. water and mixed for 1 hour. After an hour of mixing, the vessel was heated to 85° C. and left under agitation for 12 hours without temperature control. After 12 hours the temperature was 41.3° C. and the vessel was reheated to 80° C. and passed through a Guerin homogenizer at 200 bar of pressure and 300 L/hr.

The homogenized mixture was cooled to 50° C. 4 g/L of CaCl₂*2H₂O was added. pH was reduced to 1.81 using 20% HCl. This mixture was agitated for 30 minutes to enable precipitation of oxalic acid (i.e., as calcium oxalate).

After maturation, the solution was adjusted back to 5.62 pH using 10% Na₂CO₃ and heated to 85° C. and left under agitation without temperature control for 14 hours, then reheated to 80° C.

After reaching 80° C. 20 g/L of Dicalite 4158 filter aid was added to the vessel and mixed for 10 minutes.

After mixing, the solution was fed to a clean Choquenet 12 m² press filter with Sefar Fyltris 25080 AM filter cloths at 1400 L/hr recycling the product back to the feed tank for 10 minutes. At the end of recycle, the flow was adjusted to 1300 L/hr and passed through the filter. Once the tank was empty an additional 50 liters of water was pushed into the filter. The fluid from this water flush and a 12 bar compression of the cake were both added to the collected permeate. The filter was cleaned after use.

The filtered permeate, water flush, and compression fluid was agitated and heated back to 80° C.

The heated mixture had 6 kg of Dicalite 4158 added thereto and was mixed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1400 L/hr.

Without cleaning the filter, 5.33 g/L of Clarcel® DICS (water permeability 2.4 Darcies to 4.0 Darcies) and 6.667 g/L of Clarcel® CBL (water permeability 0.049 Darcies to 0.101 Darcies) were added to the mixture and agitation was performed for one hour while maintaining the temperature at 80° C. This mixture was then recycled through the Dicalite coated Choquenet 12 m² press filter with Sefar Fyltris 25080 AM filter cloths at 1400 L/hr for 15 minutes. After the recycle, the tank was passed through the filter at 1350 L/hr. An additional 50 liters of flush water were pushed through the filter and permeate was collected as well. Compression fluid from the filter was not captured.

This twice filtered material was heated to 85° C. and left agitated without temperature control for 14 hours. At this point the material was reheated to 80° C. for a third filtration step.

The heated mixture had 6 kg of Dicalite 4158 added thereto and mixing was performed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1450 L/hr.

Without cleaning the filter, 5.33 g/L of Clarcel® DICS and 6.667 g/L of Clarcel® CBL were added to the mixture and agitation was performed for one hour while maintaining the temperature at 80° C. This mixture was then recycled through the Dicalite coated Choquenet 12 m² press filter with Sefar Fyltris 25080 AM filter cloths at 1600 L/hr for 15 minutes. After the recycle, the tank was passed through the filter at 1700 L/hr. An additional 50 liters of flush water was pushed through the filter and permeate was collected as well. Compression fluid from the filter was not captured.

The triple filtered permeate was cooled to 60° C. and mixed with 83% IPA at a 1:2 ratio, 2 g IPA solution for each g of scleroglucan solution. This precipitated scleroglucan fibers which can be mechanically separated from the bulk solution. In this example, a tromel separator was used to partition the precipitated fibers from the bulk liquid solution.

After recovery of the fibers they were washed with another 0.5 g 83% IPA solution for each 1 g of initial triple filtered permeate scleroglucan solution.

Wash fibers were dried in an ECI dryer with 95° C. hot water for 1 hour and 13 minutes to produce a product with 89.3% dry matter. This material was ground up and sieved to provide powder smaller in size than 250 micron. The final ground scleroglucan material is the beta-glucan material used in the Examples herein.

### Part II. Magic Lab—Miscibility of Various Beta-Glucan Suspensions in Synthetic Sea Water.

### Examples II-1 to II-5

Various solvents or solvent mixtures as shown in Table 1 were used to form a beta-glucan suspension which was then dispersed in synthetic sea water.

For Examples II-1 and II-2, a solvent mixture of 90% butanol, 10% deionized water, by weight, was prepared by combining appropriate weights of butanol and water and agitating on a stir plate at about 460 s⁻¹ to about 3,670 s⁻¹ for about 1-5 minutes.

For Example II-3, isopropanol (IPA) was used as the solvent.

For Example II-4, a mixture of mineral oil (Sigma Aldrich M1180-4L) and lecithin (TCI America TCL0023-500G) was used as the solvent. The suspension of beta-glucan in the mineral oil was 0.2 wt % lethicin. The mineral oil and beta-glucan were combined first before adding the lethicin and mixing by hand until incorporated.

For Example II-5, methyl soyate was used (a mixture of fatty acid methyl esters (FAME)) with lecithin as the solvent. The suspension of beta-glucan in the FAME was 0.2 wt % lecithin. The FAME and the beta-glucan were combined first before adding the lethicin and mixing by hand until incorporated.

The solvent or solvent mixture and the beta-glucan from Part I were mixed in appropriate proportions to make the beta-glucan suspension. The beta-glucan was added to the solvent or solvent mixture and stirred by hand until all solid appeared wetted and well-incorporated. For Example II-4, the solution was agitated until the mineral oil was evenly dispersed in the salt water; droplets of mineral oil were suspended in the salt water in the final dispersion. For Example II-5, the solution was agitated until the FAME was evenly dispersed in the salt water; droplets of FAME were suspended in the salt water in the final dispersion.

A synthetic sea water solution was prepared using deionized water and Sigma Aldrich Sea salts (S9883) at 30 g/L salt. The water was agitated on a stir plate, the sea salts were added, and the mixture was allowed to agitate until no solids are visible. The salt water was filtered through a 0.8 μm EMD Millipore Mixed Cellulose Ester filter.

Appropriate portions of the synthetic sea water and the beta-glucan suspension were weighted out for a final beta-glucan concentration of 1 g/L. The synthetic sea water was agitated on a stir plate, and the beta-glucan suspension was added. The solution was allowed to agitate until there were no visible clumps and no phase separation (or minimal phase separation in Examples II-4 and II-5).

The agitated 1 g/L solution of synthetic sea water and 35% beta-glucan suspension was then fed to an IKA® Magic Lab® in UTL configuration with a 4M rotor stator pair running unit at 26,000 rpm. The IKA® Magic Lab® is an inline mixer using a rotor stator to impart shear on the solution. The solution was processed through Magic Lab for the number of passes shown in Table 1, measuring viscosity and transmittance after each pass. As used herein, term ‘pass’ denotes feeding solution to the Magic Lab and collecting it at the discharge. One ‘pass’ means solution has been processed through the equipment one time. Each pass through the single rotor stator assembly of the Magic Lab subjected the sample to a shear rate (s⁻¹) of about 10 times the rotor speed setting in rpm for a duration of about 0.01 s to about 1 s.

To measure viscosity, the sample was allowed to settle or a centrifuge was used to expedite settling. The solution had minimal bubbles before measuring viscosity. Viscosity was measured using a Brookfield LVT viscometer. Viscosity was measured before AP25 filtration.

Transmittance was measured using a Genesys 10S UV-Vis (By Thermo Scientific) at a wavelength of 600 nm. The solution had minimal bubbles before measuring the transmittance. Viscosity was measured before AP25 filtration.

Filterability ratio determination. The procedure was carried out before any microbe formation in the solution which could negatively impact the Filterability Ratio. A Pall stainless steel filter housing (4280) was assembled with a 47 mm diameter Millipore AP25 filter (AP2504700). The dispersion of the beta-glucan suspension in synthetic sea water was passed through the housing using a flow rate of 100-300 m/min, and the filtered dispersion was used for future steps. The Pall stainless steel filter housing (4280) was assembled with 47 mm diameter, 1.2 μm pore size, EMD Millipore mixed cellulose esters filter (part #RAWP04700), with >200 mL of solution. A container was placed on a mass balance for recording mass of material passing through the filter. Pressure was applied to the filter. The filter was unplugged and pressure was adjusted to achieve a target flux of 1-3 g/s. Once target flux was established, a constant pressure was maintained and the time needed to filter 60 g, 80 g, 160 g, and 180 g of solution through the filter was measured. Filterability was determined as (time(180 g)−time (160 g))/(time(80 g)−time (60 g)). The elapsed time between the assembly of the Pall stainless steel filter with >200 mL of solution and the time to complete the passing of the 180 g solution through the filter took between 30 minutes and 4 hours.

Transmittance and filterability results are listed in Table 1.

TABLE 1
Transmittance and Filterability Ratios of dispersions of
various beta-glucan suspensions in synthetic sea water.

| | | Concentration | | | | |
|---|---|---|---|---|---|---|
| | | of beta-glucan | | | | |
| | | suspension in | | | | |
| | | carrier fluid | Magic Lab ® | Viscosity | | Filterability |
| Example | Carrier fluid | (wt %) | passes | (cps, at 12 rpm) | Transmittance | ratio |
| II-1 | 90% Butanol/ | 35% | 3 | 70 | 99.3% | 1.08 |
| | 10% water | | | | | |
| II-2 | 90% Butanol/ | 35% | 6 | 70 | 99.7% | 1.11 |
| | 10% water | | | | | |
| II-3 | Isopropanol | 40% | 6 | 75 | 96.8% | 1.10 |
| II-4 | Mineral oil + | 20% | 6 | 75 | 4.0% | 1.76 |
| | lecithin | | | | | |
| II-5 | FAME + | 40% | 6 | 47.5 | 4.2% | 6.73 |
| | lecithin | | | | | |

### Part III. Stir Plate—Dispersibility of Beta-Glucan Suspension in Synthetic Sea Water.

### Example III-1. 35% BG Suspension in 90% Butanol/10% Water

A solvent mixture of 90% butanol, 10% deionized water, by weight, was prepared by combining appropriate weights of butanol and water and agitating on a stir plate.

The solvent mixture was combined with the beta-glucan from Part I having a particle size of <250 μm were mixed in appropriate proportions to form a suspension that was 35% beta-glucan by weight. The beta-glucan was added to the butanol/water solution and the mixture was stirred by hand until all solid appeared wetted and well-incorporated.

A synthetic sea water solution was prepared using deionized water and Sigma Aldrich sea salts (S9883) at 30 g/L salt. The water was agitated on a stir plate, the sea salts were added, and the mixture was allowed to agitate until no solids are visible. The salt water was filtered through a 0.8 μm EMD Millipore Mixed Cellulose Ester filter.

Appropriate portions of the synthetic sea water and the beta-glucan suspension were weighted out for a final beta-glucan concentration of 1 g/L. The synthetic sea water was agitated on a stir plate, and the beta-glucan suspension was added. The solution was allowed to agitate at about 460 s⁻¹ to about 3,670 s⁻¹ for 2 hours before measuring viscosity, transmittance, and filterability. The filterability was measured as described in Part II.

To measure viscosity, the sample was allowed to settle or a centrifuge was used to expedite settling. The solution had minimal bubbles before measuring viscosity. Viscosity was measured using a Brookfield LVT viscometer. Viscosity was measured prior to AP25 filtration.

Transmittance was measured using a Genesys 10S UV-Vis (By Thermo Scientific) at a wavelength of 600 nm. The solution had minimal bubbles before measuring the transmittance. Transmittance was measured before AP25 filtration.

The transmittance of solution agitated on a stir plate for 2 hours was 99.6%. The viscosity at 12 rpm was 92.5 cps. The Filterability Ratio was 1.62.

The terms and expressions that have been employed are used as terms of description and not of limitation, and there is no intention in the use of such terms and expressions of excluding any equivalents of the features shown and described or portions thereof, but it is recognized that various modifications are possible within the scope of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Additional Aspects

The following exemplary aspects are provided, the numbering of which is not to be construed as designating levels of importance:

Aspect 1 provides a readily water-dispersible beta-glucan (BG) suspension comprising:
an organic fluid that comprises an alcohol, an alpha-hydroxy acid alkyl ester, a polyalkylene glycol alkyl ether, or a combination thereof; and
a BG;
wherein the suspension is sufficient such that mixing with water at a shear rate less than about 40,000 s⁻¹ forms a homogeneous mixture of the BG and the water.

Aspect 2 provides the suspension of Aspect 1, wherein the homogeneous mixture of the BG and the water is a homogeneous mixture of the BG, the organic fluid, and the water.

Aspect 3 provides the suspension of any one of Aspects 1-2, wherein the mixing of the suspension with the water to form the homogeneous mixture of the BG and the water comprises a maximum shear rate of less than about 40,000 s⁻¹.

Aspect 4 provides the suspension of any one of Aspects 1-3, wherein the mixing of the suspension with the water to form the homogeneous mixture of the BG and the water comprises a maximum shear rate of about 100 s⁻¹ to less than about 40,000 s⁻¹.

Aspect 5 provides the suspension of any one of Aspects 1-4, wherein the mixing of the suspension with the water to form the homogeneous mixture of the BG and the water is performed for about 10 seconds to about 48 hours.

Aspect 6 provides the suspension of any one of Aspects 1-5, wherein the mixing of the suspension with the water to form the homogeneous mixture of the BG and the water is performed for about 1 minute to about 12 hours.

Aspect 7 provides the suspension of any one of Aspects 1-6, wherein the BG is about 0.001 wt % to about 10 wt % of the homogeneous mixture of the BG and the water.

Aspect 8 provides the suspension of any one of Aspects 1-7, wherein the BG is about 0.01 wt % to about 1 wt % of the homogeneous mixture of the BG and the water.

Aspect 9 provides the suspension of any one of Aspects 1-8, wherein the mixing of the suspension with the water is performed at a temperature of about 0° C. to about 150° C.

Aspect 10 provides the suspension of any one of Aspects 1-9, wherein the mixing of the suspension with the water is performed at a temperature of about 20° C. to about 50° C.

Aspect 11 provides the suspension of any one of Aspects 1-10, wherein the mixing with water is performed at a pressure of about 0.1 MPa to about 100 MPa.

Aspect 12 provides the suspension of any one of Aspects 1-11, wherein the mixing with water is performed at a pressure of about 0.1 MPa to about 1 MPa.

Aspect 13 provides the suspension of any one of Aspects 1-12, wherein the homogeneous mixture of the BG and the water has a transmittance of greater than about 95.0% at 600 nm.

Aspect 14 provides the suspension of any one of Aspects 1-13, wherein the homogeneous mixture of the BG and the water has a transmittance of about 95.0% to about 100% at 600 nm.

Aspect 15 provides the suspension of any one of Aspects 1-14, wherein the homogeneous mixture of the BG and the water has a Filterability Ratio of less than about 1.5.

Aspect 16 provides the suspension of any one of Aspects 1-15, wherein the homogeneous mixture of the BG and the water has a Filterability Ratio of less than about 1.2.

Aspect 17 provides the suspension of any one of Aspects 1-16, wherein the homogeneous mixture of the BG and the water is substantially free of fish eyes.

Aspect 18 provides the suspension of any one of Aspects 1-17, wherein the BG of the suspension is substantially fully dissolved in the homogeneous mixture of the BG and the water.

Aspect 19 provides the suspension of any one of Aspects 1-18, wherein the water comprises fresh water, salt water, brine, produced water, flowback water, brackish water, sea water, synthetic sea water, or a combination thereof.

Aspect 20 provides the suspension of any one of Aspects 1-19, wherein the water has a salt concentration of 1,000 ppm to about 300,000 ppm.

Aspect 21 provides the suspension of any one of Aspects 1-20, wherein the water comprises NaBr, CaCl₂, CaBr₂, ZnBr₂, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof.

Aspect 22 provides the suspension of any one of Aspects 1-21, wherein the BG in the suspension is substantially in the form of a solid and the organic fluid in the suspension is in the form of a liquid.

Aspect 23 provides the suspension of any one of Aspects 1-22, wherein the BG is homogeneously distributed in the organic fluid.

Aspect 24 provides the suspension of any one of Aspects 1-23, wherein the BG is about 10 wt % to about 60 wt % of the suspension.

Aspect 25 provides the suspension of any one of Aspects 1-24, wherein the BG is about 20 wt % to about 50 wt % of the suspension.

Aspect 26 provides the suspension of any one of Aspects 1-25, wherein the BG is a 1,3 beta-glucan.

Aspect 27 provides the suspension of any one of Aspects 1-26, wherein the BG is a 1,3-1,6 beta-D-glucan.

Aspect 28 provides the suspension of any one of Aspects 1-27, wherein the BG is a 1,3-1,4 beta-D-glucan.

Aspect 29 provides the suspension of any one of Aspects 1-28, wherein the BG is scleroglucan.

Aspect 30 provides the suspension of any one of Aspects 1-29, wherein the BG is schizophyllan.

Aspect 31 provides the suspension of any one of Aspects 1-30, wherein the BG has a particle size of about 10 microns to about 1,000 microns.

Aspect 32 provides the suspension of any one of Aspects 1-31, wherein the BG has a particle size of about 100 microns to about 500 microns.

Aspect 33 provides the suspension of any one of Aspects 1-32, wherein the organic fluid is about 20 wt % to about 90 wt % of the suspension.

Aspect 34 provides the suspension of any one of Aspects 1-33, wherein the organic fluid is about 40 wt % to about 80 wt % of the suspension.

Aspect 35 provides the suspension of any one of Aspects 1-34, wherein the organic fluid is or comprises the alcohol.

Aspect 36 provides the suspension of Aspect 35, wherein the alcohol comprises a single —OH group or a plurality of —OH groups.

Aspect 37 provides the suspension of any one of Aspects 35-36, wherein the alcohol is a substituted or unsubstituted (C₁-C₂₀)alcohol.

Aspect 38 provides the suspension of any one of Aspects 35-37, wherein the alcohol is an unsubstituted (C₁-C₈)alcohol.

Aspect 39 provides the suspension of any one of Aspects 35-38, wherein the alcohol is butanol, isopropanol, or a combination thereof.

Aspect 40 provides the suspension of any one of Aspects 1-39, wherein the organic fluid is or comprises the alpha-hydroxy acid alkyl ester.

Aspect 41 provides the suspension of Aspect 40, wherein the alpha-hydroxy acid alkyl ester is a (C₁-C₂₀)alkyl (C₂-C₂₀)alpha-hydroxy acid.

Aspect 42 provides the suspension of any one of Aspects 40-41, wherein the alpha-hydroxy acid alkyl ester is a (C₁-C₅)alkyl (C₂-C₅)alpha-hydroxy acid.

Aspect 43 provides the suspension of any one of Aspects 40-42, wherein the alpha-hydroxy acid alkyl ester is a (C₁-C₅)alkyl lactate.

Aspect 44 provides the suspension of any one of Aspects 40-43, wherein the alpha-hydroxy acid alkyl ester is ethyl lactate.

Aspect 45 provides the suspension of any one of Aspects 1-44, wherein the organic fluid is or comprises the polyalkylene glycol alkyl ether.

Aspect 46 provides the suspension of Aspect 45, wherein the polyalkylene glycol alkyl ether is a poly(C₂-C₃)alkylene glycol (C₁-C₂₀)alkyl ether.

Aspect 47 provides the suspension of any one of Aspects 45-46, wherein the polyalkylene glycol alkyl ether is a polypropylene glycol (C₁-C₅)alkyl ether.

Aspect 48 provides the suspension of any one of Aspects 45-47, wherein the polyalkylene glycol alkyl ether is dipropylene glycol methyl ether.

Aspect 49 provides the suspension of any one of Aspects 1-48, wherein the suspension further comprises water.

Aspect 50 provides the suspension of Aspect 49, wherein the suspension water is about 0 wt % to about 45 wt % of the suspension.

Aspect 51 provides the suspension of any one of Aspects 49-50, wherein the suspension water is about 2 wt % to about 40 wt % of the suspension.

Aspect 52 provides the suspension of any one of Aspects 49-51, wherein the suspension water comprises fresh water, salt water, brine, produced water, flowback water, brackish water, sea water, synthetic sea water, or a combination thereof.

Aspect 53 provides the suspension of any one of Aspects 49-52, wherein the suspension water is fresh water.

Aspect 54 provides the suspension of any one of Aspects 1-53, wherein the suspension has a pH of about 5 to about 9.

Aspect 55 provides the suspension of any one of Aspects 1-54, wherein the suspension has a pH of about 6 to about 7.5.

Aspect 56 provides the suspension of any one of Aspects 1-55, wherein a viscosity of the suspension ranges from about 0.1 to about 2 million cP at 70° C. measured at a shear rate of 100 s⁻¹.

Aspect 57 provides the suspension of any one of Aspects 1-56, wherein the suspension is sufficient such that a test mixture comprising water and the suspension subjected to a shear rate of 1,000 s⁻¹ to 400,000 s⁻¹ at standard temperature and pressure for a duration that is about 0.001 seconds to about 10 seconds obtains about 50% to about 100% of an ultimate viscosity of the test mixture, and the test mixture subjected to the same shear rate for twice the same duration at standard temperature and pressure obtains about 70% or more of the ultimate viscosity of the test mixture.

Aspect 58 provides the suspension of Aspect 57, wherein the water in the test mixture comprises fresh water, salt water, brine, produced water, flowback water, brackish water, sea water, synthetic sea water, or a combination thereof.

Aspect 59 provides the suspension of any one of Aspects 57-58, wherein the ultimate viscosity of the test mixture at 30 rpm is greater than about 2 cP and less than about 1,000 cP.

Aspect 60 provides the suspension of any one of Aspects 57-59, wherein the ultimate viscosity of the test mixture at 30 rpm is greater than about 50 cP and less than about 200 cP.

Aspect 61 provides a method of dispersing the water-dispersible BG suspension of any one of Aspects 1-60 in water, the method comprising: mixing the water-dispersible BG suspension of any one of Aspects 1-60 and water to form a mixture of the suspension and the water.

Aspect 62 provides the method of Aspect 61, wherein mixing the water-dispersible BG suspension and the water to form the mixture of the suspension and the water comprises a shear rate less than about 40,000 s⁻¹.

Aspect 63 provides the method of any one of Aspects 61-62, wherein the mixing of the water-dispersible BG suspension and water forms a homogeneous mixture of the BG and the water.

Aspect 64 provides the method of any one of Aspects 61-63, wherein the mixing comprises a maximum shear rate of about 100 s⁻¹ to about 400,000 s⁻¹.

Aspect 65 provides the method of any one of Aspects 61-64, wherein the mixing comprises a maximum shear rate of less than about 40,000 s⁻¹.

Aspect 66 provides the method of any one of Aspects 61-65, wherein the mixing comprises a maximum shear rate of about 100 s⁻¹ to about 40,000 s⁻¹.

Aspect 67 provides the method of any one of Aspects 61-66, wherein the mixing of the suspension with the water is performed at a temperature of 0° C. to about 150° C.

Aspect 68 provides the method of any one of Aspects 61-67, wherein the mixing of the suspension with the water is performed at a temperature of 70° C. to about 120° C.

Aspect 69 provides the method of any one of Aspects 61-68, wherein the mixing of the suspension with the water is performed at a temperature of about 20° C. to about 50° C.

Aspect 70 provides the method of any one of Aspects 61-69, wherein the mixing with water is performed at a pressure of about 0.1 MPa to about 100 MPa.

Aspect 71 provides the method of any one of Aspects 61-70, wherein the mixing with water is performed at a pressure of about 0.1 MPa to about 1 MPa.

Aspect 72 provides the method of any one of Aspects 61-71, wherein the mixing with the water to form the mixture of the suspension and the water comprises on-the-fly mixing.

Aspect 73 provides the method of any one of Aspects 61-72, wherein the mixing with the water to form the mixture of the suspension and the water occurs above-surface.

Aspect 74 provides the method of any one of Aspects 61-73, wherein the mixing with the water to form the mixture of the suspension and the water occurs in a subterranean formation.

Aspect 75 provides the method of any one of Aspects 61-74, further comprising placing the mixture of the suspension and the water in a subterranean formation.

Aspect 76 provides the method of Aspect 75, wherein overall time from formation of the mixture of the suspension and the water to placement of the mixture in the subterranean formation is less than about 30 minutes.

Aspect 77 provides the method of any one of Aspects 75-76, further comprising removing petroleum from the subterranean formation.

Aspect 78 provides the method of any one of Aspects 75-77, further comprising performing an enhanced oil recovery procedure in the subterranean formation using the mixture of the suspension and the water.

Aspect 79 provides the method of Aspect 78, wherein the enhanced oil recovery procedure comprises polymer flooding.

Aspect 80 provides the method of any one of Aspects 78-79, wherein the mixture of the suspension and the water in the subterranean formation sweeps petroleum in the subterranean formation toward a well.

Aspect 81 provides the method of any one of Aspects 78-80, comprising removing the petroleum from the well.

Aspect 82 provides a method of treating a subterranean formation, the method comprising:
mixing a readily water-dispersible beta-glucan (BG) suspension comprising a BG and an organic fluid that comprises an alcohol, an alpha-hydroxy acid alkyl ester, a polyalkylene glycol alkyl ether, or a combination thereof, with water to form a mixture of the suspension and the water, wherein the suspension is sufficient such that mixing with water at a maximum shear rate of less than 40,000 s⁻¹ forms a homogenous mixture of the BG and the water having a transmittance of about 95.0% to about 100% at 600 nm;
placing the mixture of the suspension and the water in a subterranean formation;
performing an enhanced oil recovery procedure in the subterranean formation using the mixture of the suspension and the water, wherein the mixture of the suspension and the water in the subterranean formation sweeps petroleum in the subterranean formation toward a well; and
removing the petroleum from the subterranean formation via the well.

Aspect 83 provides a method of making the water-dispersible BG suspension of any one of Aspects 1-60, the method comprising:
combining the BG and the organic fluid to form the water-dispersible BG suspension of any one of Aspects 1-60.

Aspect 84 provides a use of the water-dispersible BG suspension of any one of Aspects 1-60 for forming a mixture of the suspension and water for treatment of a subterranean formation.

Aspect 85 provides the suspension, method, or use of any one or any combination of Aspects 1-84 optionally configured such that all elements or options recited are available to use or select from.

1. A readily water-dispersible beta-glucan (BG) suspension comprising:
an organic fluid that comprises an alcohol, an alpha-hydroxy acid alkyl ester, a polyalkylene glycol alkyl ether, or a combination thereof; and
a BG;
wherein the suspension is sufficient such that mixing with water at a shear rate less than about 40,000 s⁻¹ forms a homogeneous mixture of the BG and the water.

2. The suspension of claim 1, wherein the homogeneous mixture of the BG and the water is a homogeneous mixture of the BG, the organic fluid, and the water.

3. (canceled)

4. The suspension of claim 1, wherein the mixing of the suspension with the water to form the homogeneous mixture of the BG and the water comprises a maximum shear rate of about 100 s⁻¹ to less than about 40,000 s⁻¹.

5. The suspension of claim 1, wherein the mixing of the suspension with the water to form the homogeneous mixture of the BG and the water is performed for about 10 seconds to about 48 hours.

6. The suspension of claim 1, wherein the BG is about 0.001 wt % to about 10 wt % of the homogeneous mixture of the BG and the water.

7. (canceled)

8. The suspension of claim 1, wherein the mixing with water is performed at a pressure of about 0.1 MPa to about 100 MPa.

9. The suspension of claim 1, wherein the homogeneous mixture of the BG and the water has a transmittance of greater than about 95.0% at 600 nm.

10. (canceled)

11. The suspension of claim 1, wherein the homogeneous mixture of the BG and the water has a Filterability Ratio of less than about 1.2.

12. (canceled)

13. The suspension of claim 1, wherein the water has a salt concentration of 1,000 ppm to about 300,000 ppm.

14.-21. (canceled)

22. The suspension of claim 1, wherein the BG comprises scleroglucan.

23. The suspension of claim 1, wherein the BG comprises schizophyllan.

24.-64. (canceled)

65. A method of treating a subterranean formation, the method comprising:
mixing a readily water-dispersible beta-glucan (BG) suspension comprising a BG and an organic fluid that comprises an alcohol, an alpha-hydroxy acid alkyl ester, a polyalkylene glycol alkyl ether, or a combination thereof, with water to form a mixture of the suspension and the water, wherein the suspension is sufficient such that mixing with water at a maximum shear rate of less than 40,000 s⁻¹ forms a homogenous mixture of the BG and the water having a transmittance of about 95.0% to about 100% at 600 nm;
placing the mixture of the suspension and the water in a subterranean formation;
performing an enhanced oil recovery procedure in the subterranean formation using the mixture of the suspension and the water, wherein the mixture of the suspension and the water in the subterranean formation sweeps petroleum in the subterranean formation toward a well; and
removing the petroleum from the subterranean formation via the well.

66. (canceled)
